(19) United States
(12) Patent Application Publication
(10) Pub. No.: US 2010/0003360 A1
(43) Pub. Date: Jan. 7, 2010

(54) DEVICE AND METHOD FOR THE EXTRUSION OF VISCOELASTIC MATERIALS

(75) Inventors: Boris Ouriev, Niederuzwil (CH); Dieter Hofacker, Taegerwilen (CH)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Buehler AG

(21) Appl. No.: 12/439,304

(22) PCT Filed: Aug. 28, 2007
(86) PCT No.: PCT/CH2007/000424

§ 371 Date: May 7, 2009

(30) Foreign Application Priority Data
Sep. 1, 2006 (DE) 10 2006 041 301.6

(51) Int. Cl. B29C 47/92; B29C 47/34

(52) U.S. Cl. 425/146; 425/223; 425/145

(57) ABSTRACT

The invention is directed to a device for extruding viscoelastic matter, in particular pastas. This device has a filling area for introducing matter or constituents of the matter into the device, a conveying area for conveying and processing the flow of matter conveyed through the device, a distributor area for deforming and distributing the flow of matter to a plurality of partial flows of matter, and a die area with a plurality of dies for forming a strand or sheet from the respective partial flows of matter. According to the invention, the inner walls of the distributor area are formed from a viscoelastic material at least in some areas or have a viscoelastic material in these areas.

The present application claims priority from PCT Patent Application No. PCT/CH2007/000424 filed on Aug. 28, 2007, which claims priority from German Patent Application No. DE 10 2006 041 301.6 filed on Sep. 1, 2006, the disclosure of which is incorporated herein by reference in its entirety.

### BACKGROUND OF THE INVENTION

1. Field of the Invention

The invention is directed to a device for the extrusion of viscoelastic matter, in particular for the extrusion of dough, with a step for forming strands or flat, foliate or sheetlike shapes from the viscoelastic matter.

2. Description of Related Art

Known devices for extrusion have a filling area for introducing matter or constituents of matter into the device, a conveying area for conveying and processing the flow of matter conveyed through the device, a distributor area for deforming and distributing the flow of matter to a plurality of partial flows of matter, and a die area with a plurality of dies for forming a strand or sheet from the respective partial flows of matter.

During the conveying, processing, distributing and forming of strands, flat shapes, or the like, relative flow processes take place in the interior of a viscoelastic matter between different areas of the matter and tensions develop in the matter at the same time.

These tensions are quickly reduced by compensating flow processes only in part, while a residual proportion of tension enters into the deformed matter, e.g., into the strands or flat shapes. Particularly when forming strands or (foliate or sheetlike) flat shapes from viscoelastic matter of this kind, the flow processes and tensions occurring inside the matter are very considerable due to the intensive deformation and distribution of the flowing matter so that the corresponding residual tensions in the strands or flat shapes are also high. This leads to internal forces and unwanted distortions in the deformed shapes (strands or flat shapes) resulting in particular in a tendency for the strands to twist or curl and in distortions in flat shapes, i.e., undesirable deviations from the straight or flat shape.

These problems are especially pronounced when extruding strands from dough to form specially shaped pastas (e.g., spaghetti) which then deviates from the straight shape. In extreme cases, this can even result in complete or compound curling of the strands.

### SUMMARY OF THE INVENTION

It is the object of the invention to substantially eliminate such tensions in the extruded strands and flat shapes of viscoelastic matter or at least to reduce them to the extent that there are no sharp deviations from straightness of from the flat shape under normal conditions of strand extrusion or sheet extrusion.

According to the invention, this object is met in a known device of the type described above in that the inner walls of the distributor area are also formed from a viscoelastic material at least in some areas or have a viscoelastic material in these areas.

To avoid confusion, the material to be deformed will always be referred to hereinafter as “viscoelastic matter” which flows under normal operating conditions (temperature, pumping capacity), while the “viscoelastic material” in the wall areas is generally a synthetic material which, while elastically deformable under normal operating conditions, cannot flow therefrom.

The viscoelastic areas can be constructed as cushiony elements having a closed flexible shell or chamber which is filled with a filling of viscoelastic material. The filling can be any viscoelastic material. At one extreme is a purely viscous filling material without elastic components. In this case, a material with elastic components and no viscous components is selected as the shell material. At the other extreme is a purely elastic filling material without viscous components. In this case, the shell is superfluous.

It is important that the inner walls of the distributor area are resiliently and elastically deformable at least in some areas, but cannot flow therefrom. Therefore, at least the shell material must be purely elastic without viscous components.

Solid, elastically deformable elements can also be used instead of the above-mentioned cushions with an elastic shell and a filling material having at least one viscous component.

The viscoelastic areas can also have one or more gas-filled chambers, wherein the shell material forming the chambers is a flexible material whose flexibility is due to the thin-walls and/or elasticity of the shell material.

In conventional distributor areas with consistently rigid inner walls, asymmetric velocity profiles result when the viscoelastic matter is pressed through the curved distributor channels. This asymmetry of the velocity profiles is incompatible with the symmetrical dies arranged at the end of the distributor channels for forming strands or sheets and leads to unwanted tensions in the formed strands or sheets of matter.

In the distributor area with curved channels in which an intensive deformation (sheet extrusion) and also, as the case may be, a splitting (strand extrusion) of the viscoelastic matter to be processed takes place, the inventive flexibility and elastic deformability of the inner walls at least in some portions of this distributor area results in an improved reduction at least of the asymmetrical mechanical tensions in the deforming viscoelastic matter and a sharp suppression of the tendency to develop such tensions. This is accomplished in that the development of asymmetrical velocity profiles in the curved areas of the distributor channels which accompanies the formation of at least asymmetrical material tensions is substantially prevented and, on the whole, the remaining, substantially symmetrical velocity profiles are less pronounced. In other words, the device according to the invention generates flatter, more uniform velocity profiles whose symmetry is adapted to the symmetry of the die(s).

In a particularly advantageous embodiment of the device according to the invention, the inner walls of the dies are also formed of a viscoelastic material at least in some areas. This step makes it possible to prevent or mitigate possible residual tensions, but above all asymmetric residual tensions, also in the dies, i.e., in the final phase of deformation.

While the development of near-parabolic velocity profiles in the substantially laminar flow of viscoelastic matter is inevitable due to the wall friction which is always present in practice, the present invention ensures that there are substantially symmetrical and flat velocity profiles following the distributor area at the entrance into the die(s) and preferably also after the passage of the matter through the die(s).

The viscoelastic material on or in the walls can have an elastomer.

The viscoelastic material is advisably embedded in recesses (cavities) in the inner walls of the device. During operation, it comes into contact with the viscoelastic matter and carries out the compensating movements as a result of which the velocity profiles in the flowing matter are made more uniform or the uniformity of the velocity profiles is maintained. By “uniformity” is meant the flattest possible velocity profile whose symmetry is adapted as well as possible to the die symmetry.

In an alternative construction, the viscoelastic material embedded in the inner-wall recesses (cavities) of the device is formed by a portion of the viscoelastic matter located in the inner-wall recesses (cavities). The inner-wall recesses are used in this case specifically as dead zones for the viscoelastic matter to be deformed which therefore takes over the function of the viscoelastic material described above. This constitutes an exception to the distinction between “viscoelastic matter” and “viscoelastic material.”

The inner-wall recesses (cavities) are preferably arranged at the inner wall portions where the flow of viscoelastic matter is locally accelerated. This local acceleration of the viscoelastic matter is counteracted by the compensating movements of the viscoelastic material.

The inner walls of the distributor area in their entirety are advisably formed of a viscoelastic material. In this case, a full lining of the dies is used.

Alternatively or in addition, the inner walls of the die(s) in their entirety can also be formed of a viscoelastic material. In this case, a full lining of the distributor is used.

During operation, compensating movements or compensating deformations of the viscoelastic material (“passive peristalsis”) occur in the areas of these linings.

The distributor area is preferably formed in its entirety of a viscoelastic material.

Alternatively or in addition, the dies can also be formed in their entirety from a viscoelastic material.

It is advantageous when the partial areas in which the viscoelastic material is arranged are dead zones or retention zones of the flow of matter.

In addition to the passive steps mentioned above for homogenizing the velocity profiles, active measures can also be provided in the device according to the invention.

A controllable valve can be arranged between the distributor area and the respective dies of the die area.

In this connection, it is advantageous when the device also has a pressure sensor upstream of the respective valve.

The respective valve is preferably controllable as a function of pressure signals of the pressure sensor.

The cushiony areas described above can also be provided with active elements.

The viscoelastic areas can be constructed as cushiony elements which have a closed flexible shell or chamber which is filled with a filling of viscoelastic material.

The filling of the cushions can be any viscoelastic material which communicates with a controllable pressure source. As was mentioned earlier with regard to the cushiony elements, the viscoelastic filling material can be a liquid or a gas that is enclosed by a flexible shell.

It is also important in this regard that the inner walls of the distributor area are resiliently and elastically deformable at least in some areas, but cannot flow therefrom. Therefore, at least the shell material must be purely elastic without viscous components.

Solid, elastically deformable elements which can be bent, pressed, elongated, twisted or otherwise deformed by actuators can also be used instead of the cushions with an elastic shell and a filling material having at least one viscous component.

The deformation of the cushiony areas by the active elements, e.g., pressure source, actuator, etc., is preferably carried out depending on pressure signals from additional pressure sensors arranged in the distributor area and/or die area of the device according to the invention.

Further advantages, features and possible applications of the invention are indicated in the following description of embodiment examples, which are not to be interpreted as limiting, with reference to the accompanying drawings.

### BRIEF DESCRIPTION OF THE DRAWINGS

FIG. 1 is a sectional view of a portion (distributor area and die area) of a first embodiment example of the device according to the invention along a vertical plane which contains the longitudinal axis of the device;

FIG. 2 is a sectional view of a portion (distributor area and die area) of a second embodiment example of the device according to the invention along the vertical plane which contains the longitudinal axis of the device;

FIG. 3 shows an enlarged sectional view of a portion (die only) of the first embodiment example of the device according to the invention along the vertical plane which contains the longitudinal axis of the device;

FIG. 4 is an enlarged sectional view of a portion (die only) of the second embodiment example of the device according to the invention along the vertical plane which contains the longitudinal axis of the device; and

FIG. 5 is a sectional view of a portion (conveying area, distributor area and die area) of a third embodiment example of the device according to the invention along a vertical plane which contains the longitudinal axis of the device.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

Hereinafter, the viscoelastic matter to be processed and deformed will be referred to simply as “matter.”

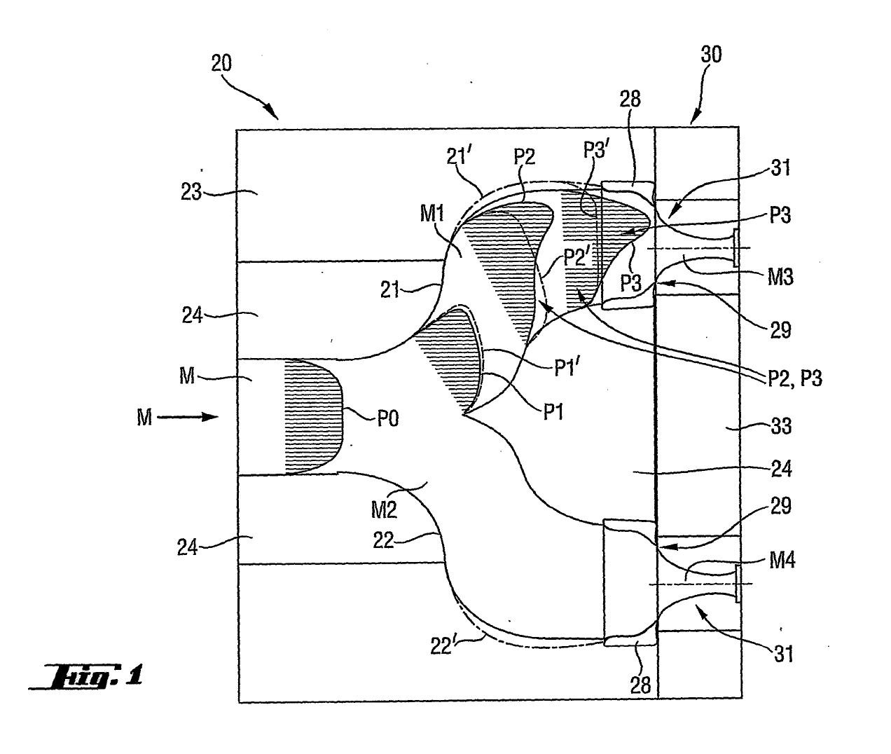

FIG. 1 is a sectional view of a distributor area 20 and a die area 30 of a first embodiment example of the device according to the invention along a vertical plane which contains the longitudinal axis of the device.

The distributor area 20 has two curved channels 21 and 22 in which the matter M is divided into a first partial flow of matter M1 and a second partial flow of matter M2. The distributor area 20 is formed by a housing 23 and an insert 24 which is inserted into the housing 23 and which can comprise more than one piece. The housing 23 is preferably made of metal, while the insert 24 is preferably made of a polymer such as, e.g., Teflon, PEEK, or the like.

The die area 30 has two dies 31 which are inserted into a die plate 33. Each die 31, 31 connects to one of the curved channels 21, 22. The die plate is preferably made of metal, while the dies 31, 31 are made of metal or a polymer such as Teflon, PEEK, or the like.

The curved channels 21, 22 are indicated by a solid line. The successive velocity profiles PI, P2 and P3 in the flow direction of the partial flows of matter Ml and M2 flowing in the curved channels 21, 22 correspond to this channel geometry. These profiles are shown only for the upper curved channel 21. However, they are also formed in the same way in the lower channel 22 symmetric to those of the upper channel 21. Recesses (cavities) indicated by dashed lines 21′ and 22′, respectively, are incorporated into the walls of the channels 21, 22 at the locations where the matter Ml and M2 is locally accelerated, i.e., on the walls in the “outside curve” of the curved channels 21, 22. The velocity profiles P1′, P2′ and P3′ of the partial flows of matter M1 and M2 flowing in the curved channels 21′, 22′ correspond to this channel geometry outfitted with the recesses 21′, 22′. These modified velocity profiles which occur as a result of the wall recesses in the areas of local acceleration are much flatter than profiles P1, P2 and P3. Further, these profiles P1′, P2′ and P3′ are practically just as highly homogenized as profile P0 of the flow of matter M before the latter is divided into the partial flows of matter M1 and M2.

Another insert 28 which is preferably made of the same material as insert 24 is arranged at the respective channel-die transition from the curved channels 21 and 22 to the respective die 31. The inserts 28 optimize the shape of the wall between channel 21 or 22 and the respective die 31 following the latter. In this respect, it is important that this wall shape or wall profile has an inflection point 29. Naturally, the dies 31 can also be constructed to be correspondingly longer so that a die of this kind is formed of the insert 28 and the die 31 integrally.

The steps mentioned above ensure that velocity profiles P1′, P2′ and P3′ which are relatively flat and uniform across the channel cross section and whose symmetry is adapted to the die symmetry are generated in spite of the directional deflection of the partial flows of matter M1 and M2. As a result, the strands M3 and M4 of matter or sheets M3 and M4 of matter proceeding from the partial flows of matter Ml and M2 exit the dies 31 after their final deformation with very few tensions overall, these tensions being predominantly symmetric to the strand shape or sheet shape.

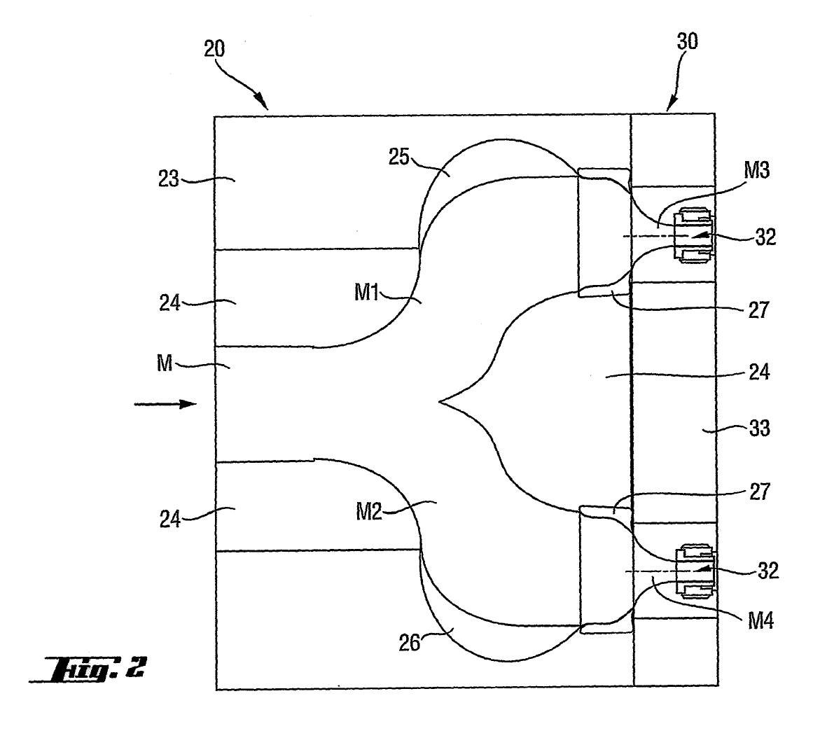

FIG. 2 shows a sectional view of a distributor area 20 and a die area 30 of a second embodiment example of the device according to the invention along a vertical plane containing the longitudinal axis of the device.

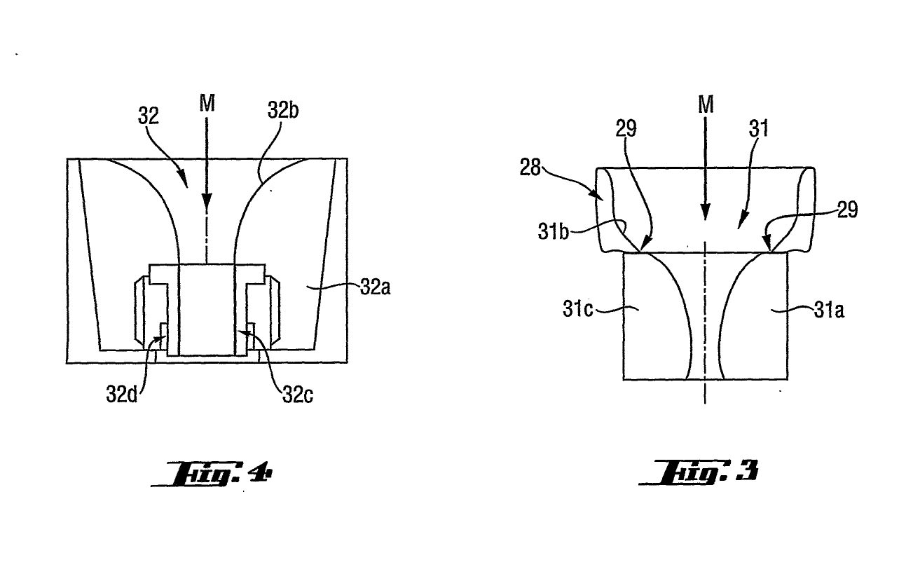

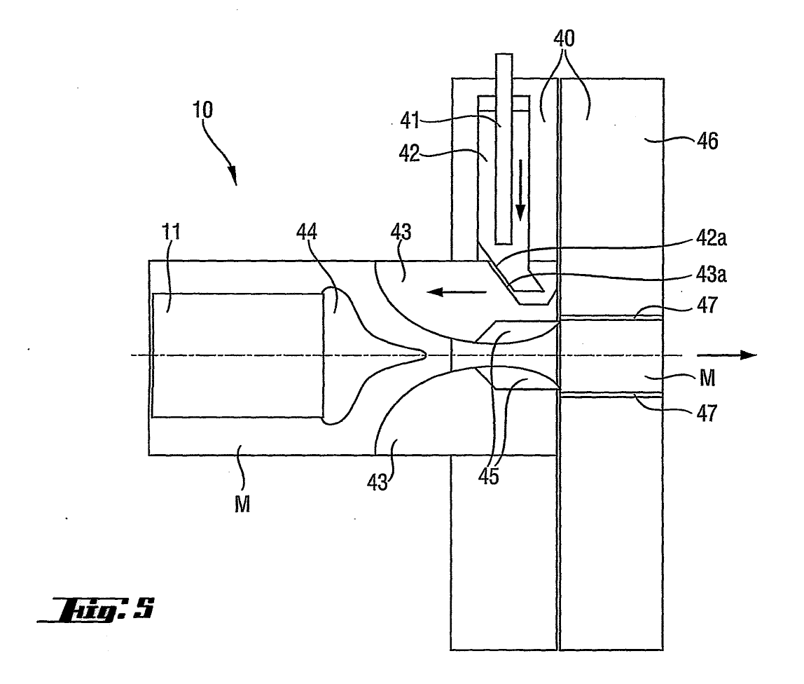

The second embodiment example is distinguished from the first embodiment example in that:
1) instead of recesses 21′, 22′, the channels 21 and 22 are outfitted in each instance with an insert of viscoelastic material 25 and 26, respectively, which is inserted in recesses of the channel wall;
2) instead of the inserts 28 at the transitions between the channel and die, an insert 27 of viscoelastic material is provided; and
3) instead of dies 31 (see FIG. 3), dies 32 having a different shape (see FIG. 4) are provided.

The parts identical to those in the first embodiment example are provided with the same reference numbers as in the first embodiment example.

The inserts 25 and 26 formed of the viscoelastic material yield to pressure but are resilient. These inserts are flexible and can retard accelerated areas of the partial flows of matter M1 and M2 similar to the recesses (cavities) in the first embodiment example. They carry out a kind of passive peristalsis.

FIG. 3 shows an enlarged sectional view of a die 31 of the first embodiment example of the device according to the invention along the vertical plane which contains the longitudinal axis of the device.

The die base body 31a contains a goblet-shaped passage which widens against the flow direction of matter from the center of the die to the die entrance and with the flow direction of matter toward the die outlet as can be seen from the die wall profile 31c. The insert 28 whose passage narrows in diameter in the flow direction as can be seen from the insert wall profile 31b is arranged upstream of the die entrance. Together, the insert 28 and the die base body 31a form a die passage whose inner wall profile (31b+31c) is basically S-shaped, i.e., has an inflection point 29.

FIG. 4 shows an enlarged sectional view of a die 32 of the second embodiment example of the device according to the invention along the vertical plane which contains the longitudinal axis of the device.

The die base body 32a has a goblet-shaped portion of the passage on the die entrance side which widens against the flow direction of matter from the center of the die to the die entrance as can be seen from the die wall profile 32b. Another portion of the passage which is substantially cylindrical but is constructed adaptively is arranged on the die outlet side. A tubular or tube-like element 32c of energy-elastic or entropy-elastic material is inserted into the die base body 32a and anchored therein by frictional and/or positive engagement. The die base body 32a is cut out to a greater extent in the area of the die outlet so that an annular gap 32d is formed between the cylindrical, adaptive element 32c and the base body 32a. This allows a great flexibility of the die outlet. The flexibility of the adaptive element is determined by the Young's modulus and the wall thickness of the elastic material of the cylindrical element 32c, which is preferably an elastomer, as well as by the axial length and radial width of the annular gap 32d.

FIG. 5 is a sectional view of a conveying area 10 and a distributor area 40 of a third embodiment example of the device according to the invention along a vertical plane which contains the longitudinal axis of the device.

A portion of the conveying area 10 is indicated schematically and has an extruder screw 11. A plurality of elements 41, 42, 43 and 44 serving to adjust the channel cross section in the distributor area/transitional area 40 are located in the distributor area (or transitional area between the conveying area and the die area, not shown) 40. A spindle 41 which is rotatably mounted in the distributor housing 46 cooperates with a radial slide 42 by means of a thread connection (not shown) so that the slide 42 can be moved in radial direction by rotation of the spindle 41. The radial slide 42 in turn cooperates with an axial slide 43 by means of a sliding connection. This sliding connection is formed by a sliding surface 42a of the radial slide 42 and a sliding surface 43a of the axial slide 43 which contact one another. An annular channel through which the matter M flows and whose cross section can be adjusted by the axial displacement of the axial slide 43 by actuation of the spindle 41 is located between an element 44, which is arranged in the center in the area of the end of the screw and which narrows in diameter along the flow direction of matter, and the axial slide 43.

The axial slide 43 has a passage which extends in axial direction and which is goblet-shaped similar to the die 31. Further, adaptive, i.e., elastomeric, elements 45 having an effect similar to that of the elements 25, 26, 27 and 32c described above are arranged in this goblet-shaped passage of the axial slide 43.

A cylindrical passage which is preferably provided with a lining 47 of non-stick material adjoins the goblet-shaped passage of the axial slide 43. The elements 43 and 44 are preferably also made of a non-stick material of this kind or are coated with such a material.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10 conveying area
11 extruder screw
20 distributor area
21 channel
22 channel
23 housing
24 insert
25 insert/viscoelastic insert
26 inflection point/viscoelastic insert
27 viscoelastic insert
28 insert
29 inflection point
29 die area
30 die
31a die base body
31b insert wall profile
31c die wall profile
31 die
32a die base body
32b die wall profile
32c tubular or tube-like element
32d annular gap
32 die plate
40 distributor area
41 spindle
42 radial slide
42a sliding surface
43 axial slide
43a sliding surface
44 element narrowing in diameter
45 elastic element
46 distributor housing
47 lining
M matter
M1 first partial flow
M2 second partial flow
M3 strand or sheet
M4 strand or sheet
P0 velocity profile
P1 velocity profile
P2 velocity profile
P3 velocity profile
P1′ velocity profile
P2′ velocity profile
P3′ velocity profile

1. A device for extruding viscoelastic matter comprising:
a filling area for introducing matter or constituents of matter into the device;
a conveying area for conveying and processing the flow of matter conveyed through the device;
a distributor area for deforming and distributing the flow of matter to a plurality of partial flows of matter; and
a die area with a plurality of dies for forming a strand or sheet from the respective partial flows of matter;
wherein the inner walls of the distributor area are formed from a viscoelastic material at least in some areas or have a viscoelastic material in these areas.

2. The device according to claim 1; characterized in that the inner walls of the dies are formed of a viscoelastic material at least in some areas.

3. The device according to claim 1; wherein the viscoelastic material has an elastomer.

4. The device according to claim 1;
wherein the viscoelastic material is embedded in recesses in the inner walls of the device.

5. The device according to claim 4;
wherein the viscoelastic material is formed by a portion of the viscoelastic matter located in the inner-wall recesses.

6. The device according to claim 5;
wherein the inner-wall recesses are arranged at inner wall portions where the flow of viscoelastic matter is locally accelerated.

7. The device according to claim 1;
wherein the inner walls of the distributor area in their entirety are formed of a viscoelastic material.

8. The device according to claim 1;
wherein the inner walls of the dies in their entirety are formed of a viscoelastic material.

9. The device according to claim 1;
wherein the entire distributor area is formed of a viscoelastic material.

10. The device according to claim 1;
wherein the dies in their entirety are formed of a viscoelastic material.

11. The device according to claim 1;
wherein the partial areas are dead zones or retention zones of the flow of matter.

12. The device according to claim 1;
wherein a controllable valve is arranged between the distributor area and the respective dies of the die area.

13. The device according to claim 12;
wherein the device has a pressure sensor upstream of the respective valve.

14. The device according to claim 13;
wherein the respective valve is controllable as a function of pressure signals of the pressure sensor.
